(19) United States
(12) Patent Application Publication
(10) Pub. No.: US 2021/0059269 A1
(43) Pub. Date: Mar. 4, 2021

(54) PROCESSING METHOD FOR SWEET POTATO ENABLING LONG-TERM PRESERVATION AT ROOM TEMPERATURE AND SWEET POTATO PROCESSED FOOD PREPARED THEREFROM

(71) Applicant: Kyung Up RYU, Chungcheongnam-do (KR)

(72) Inventor: Kyung Up RYU, Chungcheongnam-do (KR)

(21) Appl. No.: 16/772,340

(22) PCT Filed: Nov. 21, 2018
(86) PCT No.: PCT/KR2018/014314

§ 371 Date: Jun. 12, 2020

(30) Foreign Application Priority Data
Dec. 12, 2017 (KR) 10-2017-0170548

(51) Int. Cl. A23B 7/01; A23B 7/16

(52) U.S. Cl. CPC A23B 7/01; A23B 7/16

(57) ABSTRACT

A sweet potato processed food can be preserved at room temperature for a long period of time while maintaining the taste, palatability, or the like acquired right after preparation procedures, given that the processed food is prepared by a process including: (1) washing and drying a sweet potato; (2) packaging each sweet potato of the step (1) in a laminated foil packaging sheet; and (3) pasteurizing the packaged sweet potato of the step (2) at 121 to 150° C. for 25 to 35 minutes. It is therefore expected to increase the income of sweet potato farmers and ensure high industrial availability by using the method for processing sweet potatoes into baked or steamed sweet potatoes that are readily consumable without trouble to conduct a separate cooking procedure, distributable at room temperature, and preservable for a long period of time.

### BACKGROUND

The present invention relates to a processing method for sweet potato that enables long-term preservation of sweet potatoes at room temperature, and a sweet potato processed food prepared therefrom.

As the standards of living have greatly improved in recent times, peoples' dietary culture and life have changed towards a soaring increase in the consumption of animal-based food products and relatively a decrease in the consumption of root and tuber crops and grain-based food products along with an elevated economic level, which accounts for the increasing risk of chronic and degenerative diseases such as obesity or cardiovascular diseases caused by poor nutrition or unbalanced malnutrition. More attention has therefore been drawn to well-being health food products, a typical one of which is sweet potatoes.

The sweet potato (Ipomoea batatas) is an edible dicotyledonous plant that belongs to the morning glory family. It is native to Latin America and has long been used as food resource in Korea since its first introduction in 1796. Compared to other food crops, the sweet potato is less affected by its growing conditions, easier to grow, and very productive with higher yields per unit area, so it is widely cultivated in Korea (Hwang, I. G., et al., 2014).

The sweet potato, a high-calorie food product loaded with calories about double the calorie content of potatoes, contains mostly carbohydrates and other sweet components, such as sucrose, glucose and fructose. It is also rich in dietary fiber and alapin, which offer a beneficial effect to improve constipation, and inorganic components, such as vitamin C, potassium, calcium, iron, etc. (Kim, S. Y., et al., 2017). Further, sweet potatoes are reported to have antioxidant (Kim, D. S., et al., 2015), antimutagenic (Park, J. S., et al., 2011) and antiallergic (Kwak, C. S., et al., 2013) effects and therefore increasingly expected to be available as a functional food material.

Yet, sweet potatoes are vulnerable to high humidity and bright light and very susceptible to chilling injury, which accounts for sweet potatoes being sensitive to temperature. On account of this, there is a difficulty in storing sweet potatoes; that is, sweet potatoes must be stored in airy shade at temperatures from 12° C. to 15° C. The conventional methods of consuming sweet potatoes as a food are categorized into, but limited to, eating raw, steaming, and baking. Besides, sweet potatoes are not easy to consume during the off-season other than a harvest season from July to November and a post-harvest storage season from October to March. It is therefore generally considered that sweet potatoes are available as a food only in the winter season. As the sweet potatoes have recently been known to have various physiological efficacies and recognized as a weight-control and health functional food, many attempts have been made to develop methods for storing and processing sweet potatoes.

One of the latest methods for storing sweet potatoes involves procedures of baking, quick cooling and keeping frozen. Yet, this method needs the hassle of keeping the baked sweet potatoes frozen during distribution and thawing the frozen sweet potatoes prior to consumption. Further, when the thawing process causes the sweet potatoes to lose some water to the surface of their skin, it possibly spoils the visual appearance of the sweet potatoes, brings the consumer irritated to the mouth while eating the sweet potatoes, and deteriorates the texture and taste of the sweet potatoes in the course of freezing and thawing.

Therefore, the inventors of the present invention have made sustained studies on the processing method for sweet potato and found out a method for processing sweet potatoes into baked or steamed sweet potatoes that are capable of being preserved at room temperature for a long time while maintaining the taste, flavor and texture (mouthfeel) of sweet potatoes, thereby completing the present invention.

As for the prior art, JP Patent Laid-Open Publication Nos. 07095849, 08214769 and 022422634 disclose methods for preparing a baked sweet potato that is made preservable at room temperature for a long time through pasteurization. These cited patents are somewhat similar in structure to the present invention, yet not specifying or implying the structure of the present invention that a sweet potato processed food prepared by using red clay under conditions for pasteurization can be preserved at room temperature for one year or longer. In addition, KR Patent Laid-Open Publication No. 2011-0025305 discloses a baked sweet potato prepared in a red clay kiln, but does not specify or imply the structure of the present invention in association with the sweet potato being preservable at room temperature for one year or longer.

### RELATED ART DOCUMENTS

### Patent Documents

(Patent Document 0001) JP Patent Laid-Open Publication No. 07095849, “Production of roasted sweet potato distributable at normal temperature and preservable for long period of time”, published on Apr. 11, 1995.
(Patent Document 0002) JP Patent Laid-Open Publication No. 08214769, “Preparation of roast sweet potato preservable for long period at normal temperature”, Aug. 27, 1996.
(Patent Document 0003) JP Patent Laid-Open Publication No. 022422634, “Preparation of roast sweet potato preservable for long period of time at normal temperature”, published on Sep. 27, 1990.
(Patent Document 0004) KR Patent Laid-Open Publication No. 2011-0025305, “Method for coating red-clay baked sweet potato with red clay water, published on Mar. 10, 2011.

### Non-Patent Documents

(Non-Patent Document 0001) Ahn, Y. B. et al., “Quality characteristics of fermented wild grass juice”, J. Korean Soc. Food Sci. Nutr., 43(11), 1731-1736, 2014.
(Non-Patent Document 0002) Hwang. I. G. et al., “Vitamin C quantification of Korean sweet potatoes by cultivar and cooking method”, J. Korean Soc. Food Sci. Nutr., 43(6), 955-961, 2014.
(Non-Patent Document 0003) Kim, D. S. et al., “Antioxidant activities of extracts prepared from sweet potatoes with different flesh colors”, J. Appl. Biol Chem., 58(1), 21-24, 2015.
(Non-Patent Document 0004) Kim, S. Y. et al., “Food composition of raw, boiled, and roasted sweet potatoes”, Korean J. Community Living Sci., 28(1), 59-68, 2017.
(Non-Patent Document 0005) Kwak, C. S. et al., “In-vitro antioxidant, anti-allergic and anti-inflammatory effects of ethanol extracts from Korean sweet potato leaves and stalks”, J. Korean Soc. Food Sci. Nutr., 42(3), 369-377, 2013.
(Non-Patent Document 0006) Park, J. S. et al., “Antimutagenicity of Korean sweet potato (Impomea batatas L) cultivars”, J. Korean Soc. Food Sci. Nutr., 40(1), 37-46, 2011.

### SUMMARY OF THE INVENTION

It is an object of the present invention to provide a processing method for sweet potato that enables long-term preservation of sweet potatoes at room temperature, and a sweet potato processed food prepared therefrom.

In an aspect of the present invention, there is provided a processing method for sweet potato that enables long-term preservation of a sweet potato at room temperature, the processing method including: (1) washing and drying a sweet potato; (2) packaging each sweet potato of the step (1) in a laminated foil packaging sheet; and (3) pasteurizing the packaged sweet potato of the step (2) at 121 to 150° C. for 25 to 35 minutes.

The washing of the step (1) may be washing the sweet potato with a high-pressure spray of ultrasonic wash water.

The drying of the step (1) may be infrared drying.

The processing method for sweet potato may further include wrapping the sweet potato with plant leaves prior to the step (2) of packaging the sweet potato in a packaging sheet.

The plant leaves may be selected from the group consisting of mulberry leaves, lotus leaves, mandarin melon berry leaves, Siberian ginseng leaves, kalopanax leaves, kudzu leaves, basil leaves, verba mate leaves, Camellia sinensis (green tea) leaves, and pine tree leaves.

The processing method for sweet potato may further include baking the sweet potato of the step (1) to prepare a baked sweet potato.

The baked sweet potato may be prepared by placing the sweet potato in a kiln filled with a layer of red clay or covering the sweet potato with red clay in a kiln, and then baking the sweet potato at 150 to 160° C. for 80 to 100 minutes.

The long-term preservation of the sweet potato may last 12 to 18 months.

In another aspect of the present invention, there is provided a sweet potato processed food prepared by the processing method.

Hereinafter, the present invention will be described in further detail.

The present invention is directed to a processing method for sweet potato that enables long-term preservation of a sweet potato at room temperature, the processing method including: (1) washing and drying a sweet potato; (2) packaging each sweet potato of the step (1) in a laminated foil packaging sheet; and (3) pasteurizing the packaged sweet potato of the step (2) at 121 to 150° C. for 25 to 35 minutes.

The washing of the step (1) may be conducted to remove foreign materials, such as soil, dirt, bacteria, etc., from the surface of the sweet potato. The washing is eliminating foreign materials from the sweet potato to the maximum extent without scratching the surface of the sweet potato, preferably washing with a high-pressure spray of wash water.

The wash water may be, if not limited to, water, ultrasonic wash water, or ozonized wash water. The wash water is preferably ultrasonic wash water or ozonized wash water, and more preferably ultrasonic wash water.

Such a washing process allows consumption of the sweet potato processed food of the present invention without peeling the skin of the sweet potato.

The drying of the step (1) may be infrared drying using infrared radiations, which not only dries the sweet potato to completely remove water from the surface of the washed sweet potato, but also eliminates bacteria remaining on the surface of the sweet potato with infrared radiations.

The processing method for sweet potato may further include wrapping the sweet potato with plant leaves prior to the step (2) of packaging the sweet potato in a packaging sheet.

The step of wrapping the sweet potato with plant leaves is having the flavor and active ingredients of the plant leaves to penetrate into the sweet potato during the processing and thereby to enhance the processed sweet potato in quality.

The plant leaves may be the leaves of field/mountain plants.

The field/mountain plants, which are wild plants living in the field or mountain areas, have been recognized to have beneficial efficacies with plenty of vitamins, minerals, and bioactive substances and therefore widely used as foods, beverages, and so forth in Oriental medicine and folk medicine (Anh, Y. B. et al., 2014).

The plant leaves may be selected from, but are not limited to, mulberry leaves, lotus leaves, mandarin melon berry leaves, Siberian ginseng leaves, kalopanax leaves, kudzu leaves, basil leaves, verba mate leaves, Camellia sinensis (green tea) leaves, and pine tree leaves.

The laminated foil packaging sheet of the step (2) may be an aluminum pouch used as a packaging sheet in the manufacture of retort food products. The aluminum pouch is used to preserve the quality of sweet potatoes and prevent the sweet potatoes from decaying by keeping the sweet potato processed food out of contact with oxygen and providing a protective barrier from sunlight.

The laminated foil packaging sheet may be a packaging sheet with a compression-adhesive foil laminate or multiple foil laminates. The foil laminate may be single-layered, preferably 3-layered, and more preferably 5-layered.

The protective barrier against sunlight becomes more effective with an increase in the number of the foil laminates only to prevent decay of the sweet potato processed food and preserve the processed food without a decline in quality.

The pasteurizing process of the step (2) is to ensure the long-term preservation of the sweet potato processed food at room temperature and involves pasteurizing at 121° C. or above for at least 5 minutes, preferably at 121 to 150° C. for at least 20 minutes, and more preferably at 121 to 150° C. for 25 to 35 minutes.

The processing method for sweet potato may further include baking the sweet potato of the step (1) to prepare a baked sweet potato.

The baked sweet potato may be prepared by placing the sweet potato in a kiln filled with a layer of red clay or covering the sweet potato with red clay in a kiln, and then baking the sweet potato.

The red clay emits far-infrared radiation to enhance the taste of the sweet potato and make a sterilizing effect to extend the shelf life of the sweet potato.

The baked sweet potato of the present invention may be prepared by baking at 150 to 160° C. for 80 to 100 minutes. Sweet potatoes are baked normally at 190° C. for about 55 minutes. Compared to the normal baking procedure for sweet potato, the preparation method for baked sweet potato according to the present invention involves baking sweet potatoes at lower temperatures for a longer period of time only to elevate the sweetness of the sweet potatoes and render the baked sweet potatoes easier to peel.

The long-term preservation of the sweet potato may last 12 to 24 months, preferably 12 to 18 months.

The present invention is also directed to a sweet potato processed food prepared by the processing method.

The sweet potato processed food is a processed food product in the form of a steamed or baked sweet potato.

The steamed sweet potato is a sweet potato processed food prepared by the processing method that includes a first processing procedure of cooking the washed and dried sweet potato of the step (1) at high temperatures in the pasteurization process of the step (3).

The baked sweet potato is a sweet potato processed food prepared by the processing method that involves a first processing procedure of baking the washed and dried sweet potato of the step (1) in a kiln and a second processing procedure of performing the pasteurization process of the step (3) for the baked sweet potato.

The sweet potato processed food is preservable at room temperature for a long period of time, thus distributable with convenience at room temperature, readily consumable without trouble to conduct a thawing process unlike frozen sweet potato foods, and enabled to maintain the taste, flavor and texture (mouthfeel) of the sweet potatoes acquired right after the processing procedure.

The present invention relates to a processing method for sweet potato that enables a long-term preservation of sweet potatoes at room temperature, and a sweet potato processed food prepared using the same. More specifically, the sweet potato processed food is prepared by a processing method that includes: (1) washing and drying a sweet potato; (2) packaging each sweet potato of the step (1) in a laminated foil packaging sheet; and (3) pasteurizing the packaged sweet potato of the step (2) at 121 to 150° C. for 25 to 35 minutes. The sweet potato processed food thus prepared can be preserved at room temperature for a long period of time while maintaining the taste, flavor and texture (mouthfeel) of the sweet potato acquired right after the processing procedure.

The present invention is therefore expected to bring out an increase in the income of sweet potato farmers by using the processing method for sweet potatoes into baked or steamed sweet potatoes that are readily consumable without trouble to conduct a separate cooking procedure, distributable at room temperature, and preservable for a long period of time.

### BRIEF DESCRIPTION OF DRAWINGS

FIG. 1 presents experimental results showing the degree of decay in sweet potato processed foods prepared by the processing method for sweet potato according to the present invention and stored at 20 to 25° C. for five days.

### DETAILED DESCRIPTION OF THE INVENTION

The processing method for sweet potato that enables long-term preservation of a sweet potato at room temperature, and the sweet potato processed food prepared therefrom according to the present invention involve: (1) washing and drying a sweet potato; (2) wrapping the sweet potato of the step (1) with plant leaves and packaging each sweet potato in a laminated foil packaging sheet; and (3) pasteurizing the packaged sweet potato of the step (2) at 121 to 150° C. for 25 to 35 minutes, thereby having the flavor and active ingredients of the plant leaves to penetrate into the sweet potato and enhance the sweet potato processed food in quality.

Hereinafter, a detailed description will be given as to the present invention in connection with preferred embodiments. It should be understood that the embodiments are not construed to limit the scope of the present invention but intended to cover all modifications. The embodiments of the present invention are given to make the disclosure of the present invention complete and enable those skilled in the related art to completely understand the conception of the present invention.

### Examples 1 to 4: Preparation of Sweet Potato Processed Foods

(1) Washing and Drying of Sweet Potatoes

After harvest, raw sweet potatoes were washed with a high-pressure spray of ultrasonic wash water for removal of foreign materials such as soil, dirt, bacteria, etc. An infrared drying machine was used to dry the sweet potatoes and completely remove water from the surface of the sweet potatoes.

(2) Preparation of Baked Sweet Potatoes

The raw sweet potatoes washed and dried in the step (1) were baked in a kiln to prepare baked sweet potatoes. For this, the sweet potatoes were placed in a kiln filled with a layer of red clay or covered with red clay in a kiln, and then baked at 160° C. for 80 minutes.

(3) Preparation of Sweet Potato Processed Foods

Each of the raw sweet potatoes washed and dried in the step (1) or the baked sweet potatoes prepared in the step (2) was packaged in a laminated foil packaging sheet, or wrapped with a mulberry leaf or a lotus leaf and then packaged in a laminated foil packaging sheet. The packaged sweet potato was pasteurized at 121° C. for 30 to 35 minutes. As shown in Table 1 below, the pasteurization process resulted in cooking the raw sweet potato into a pasteurized sweet potato processed food in the form of a steamed sweet potato and the baked sweet potato into a pasteurized sweet potato processed food in the form of a baked sweet potato. The laminated foil packaging sheet was a packaging sheet with a single foil laminate.

TABLE 1

| Div. | Sweet potato processed food |
|---|---|
| Example 1 | Pasteurize a raw sweet potato placed in a laminated |
| | foil packaging sheet. |
| Example 2 | Pasteurize a raw sweet potato wrapped with a mulberry |
| | or lotus leaf and then placed in a laminated foil |
| | packaging sheet. |
| Example 3 | Pasteurize a sweet potato baked with red clay and then |
| | placed in a laminated foil packaging sheet. |
| Example 4 | Pasteurize a sweet potato baked with red clay, wrapped |
| | with a mulberry or lotus leaf and then placed in a |
| | laminated foil packaging sheet |

### Experimental Example 1: Preservability of Sweet Potato Processed Food

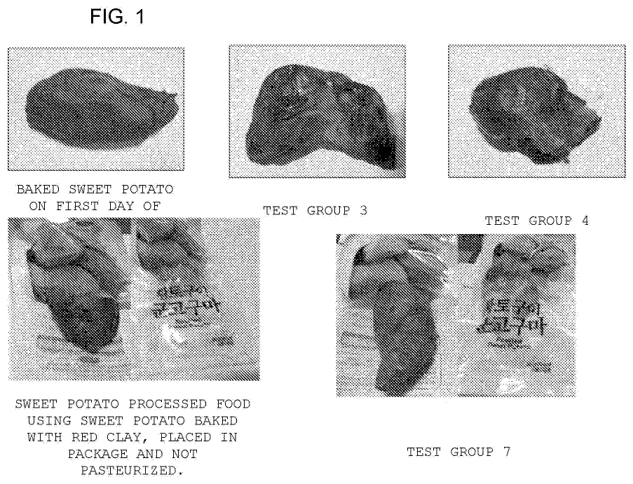

In order to examine the preservability of the sweet potato processed food of the present invention, the sweet potato processed foods of Examples 1 to 4 were kept at 20 to 25° C. and measured in regards to the time required to have decay. The decay time was averaged. The results are presented in Table 2 and FIG. 1. Referring to FIG. 1, the sweet potatoes given in Table 2 below were kept at 20 to 25° C. for 5 days and then evaluated in regards to the degree of decay.

TABLE 2

| | | Average | |
|---|---|---|---|
| Div. | Sweet potato processed foods | time to decay | |
| Test Group 1 | Raw sweet potato washed and dried | 20 | days |
| Test Group 2 | Sweet potato baked without red clay | 2 | days |
| Test Group 3 | Sweet potato baked with red clay | 4 | days |
| Test Group 4 | Sweet potato processed food from | 3 | days |
| | pasteurization of a raw sweet potato | | |
| | not placed in a package | | |
| Test Group 5 | Sweet potato processed food from | 4 | days |
| | pasteurization of a sweet potato baked | | |
| | with red clay and not placed in a package | | |
| Test Group 6 | Sweet potato processed food from | 1.5 | month |
| | pasteurization of a raw sweet potato | | |
| | placed in a packaging sheet without a | | |
| | laminated foil | | |
| Test Group 7 | Sweet potato processed food from | 6 | months |
| | pasteurization of a sweet potato baked | | |
| | with red clay and placed in a packaging | | |
| | sheet without a laminated foil | | |

| | | |
|---|---|---|
| Example 1 | Sweet potato processed food from | 18 or more |
| | pasteurization of a raw sweet potato | months |
| | placed in a laminated foil packaging sheet | |
| Example 2 | Sweet potato processed food from | 18 or more |
| | pasteurization of a raw sweet potato | months |
| | wrapped with a mulberry or lotus leaf | |
| | and then placed in a laminated foil | |
| | packaging sheet | |
| Example 3 | Sweet potato processed food from | 18 or more |
| | pasteurization of a sweet potato baked | months |
| | with red clay and then placed in a | |
| | laminated foil packaging sheet | |
| Example 4 | Sweet potato processed food from | 18 or more |
| | pasteurization of a sweet potato baked | months |
| | with red clay, wrapped with a mulberry | |
| | or lotus leaf and then placed in a | |
| | laminated foil packaging sheet | |

As can be seen from Table 2, decay appeared normally within four days of storage at 20 to 25° C. in the baked sweet potatoes (Test Groups 2 and 3), the sweet potato processed food from pasteurization of a raw sweet potato not placed in a package (Test Group 4), and the sweet potato processed food from pasteurization of a baked sweet potato not placed in a package (Test Group 5). In contrast, the sweet potato processed foods from pasteurization of sweet potatoes placed in a package (Test Groups 6 and 7, and Examples 1 to 4) had no decay in one or more months of storage at 20 to 25° C. The sweet potato processed foods using a laminated foil packaging sheet (Examples 1 to 4) had a noticeably longer shelf life at 20 to 25° C. than those not using a laminated foil packaging sheet (Test Groups 6 and 7).

As can be seen from FIG. 1, the sweet potato baked with red clay (Test Group 3) had less severe decay under same storage conditions than the sweet potato processed food from pasteurization of a raw sweet potato not placed in a package (Test Group 4). The main reason for this presumably lies in that the baking process using red clay removed part of water from the sweet potato through evaporation to reduce the water content of the sweet potato and kept the sweet potato from decaying by the sterilizing action of the red clay.

As for the pasteurization process following the packaging of the baked sweet potato, as can be seen from FIG. 1, the baked sweet potato placed in a package and not pasteurized got water formed inside the packaging sheet and started to decay in 5 days of storage at 20 to 25° C.; whereas the baked sweet potato placed in a package and then pasteurized (Test Group 7) remained in the same condition of the baked sweet potato on the first day of preparation.

If not shown in the present invention, a pasteurization time of 5 minutes in the pasteurization step of the present invention resulted in a noticeable reduction of the shelf life of the sweet potato processed foods, and a pasteurization time of 20 or more minutes allowed the baked sweet potato to be preserved for one year or longer. As for the packaging sheet of the present invention, the larger number of foil laminates led to the longer shelf life of the sweet potato processed foods and was more favored to the maintenance of the processed foods in quality.

In conclusion, the sweet potato processed foods prepared by the processing method of the present invention were preservable at room temperature for a long time, distributable at room temperature in the case of food distribution, and thus easy to distribute with convenience.

### Experimental Example 2: Sensory Evaluation of Sweet Potato Processed Food

The sweet potato processed foods of the present invention were subjected to a sensory evaluation in regards to taste, flavor, texture (mouthfeel), and ease of peeling.

50 adult sensory panelists were assigned to evaluate the sweet potato processed foods of Table 2 in regards to taste, flavor, texture, and ease of peeling on a 7-point rating scale. For taste, sweet taste was captured as a reference attribute; for flavor, sweet flavor and less burnt flavor; and for texture (mouthfeel), less dense texture and less mushy texture. As for the samples, the sweet potato processed foods of Test Groups 2, 3 and 4 were sweet potatoes processed prior to the sensory evaluations, and those of Examples 1 to 4 were kept at room temperature for one month after preparation. The evaluation was conducted for steamed sweet potatoes and baked sweet potatoes separately. The degree of liking for each sample was marked using the number scale given by: 7=like very much, 6=like moderately, 5=like slightly, 4=neither like nor dislike, 3=dislike slightly, 2=dislike moderately, 1=dislike very much. Mean liking scores are presented in Tables 3 and 4 below.

TABLE 3

| | Processed foods in the form | | | | Ease of |
|---|---|---|---|---|---|
| Div. | of baked sweet potato | Taste | Flavor | Texture | peeling |
| Test Group 2 | Sweet potato baked without red | 4.6 | 3.5 | 3.2 | 5.1 |
| | clay | | | | |
| Test Group 3 | Sweet potato baked with red | 6.4 | 5.1 | 4.7 | 6.2 |
| | clay | | | | |
| Example 3 | Sweet potato processed food from | 6.6 | 5.8 | 6.5 | 6.4 |
| | pasteurization of a sweet potato | | | | |
| | baked with red clay and then placed | | | | |
| | in a laminated foil packaging sheet | | | | |
| Example 4-1 | Sweet potato processed food from | 6.5 | 6.5 | 6.4 | 6.6 |
| | pasteurization of a sweet potato | | | | |
| | baked with red clay, wrapped with | | | | |
| | a mulberry leaf and then placed | | | | |
| | in a laminated foil packaging sheet | | | | |
| Example 4-2 | Sweet potato processed food from | 6.5 | 6.8 | 6.4 | 6.5 |
| | pasteurization of a sweet potato | | | | |
| | baked with red clay, wrapped with | | | | |
| | a lotus leaf and then placed in a | | | | |
| | laminated foil packaging sheet | | | | |

TABLE 4

| | Processed foods in the form | | | | Ease of |
|---|---|---|---|---|---|
| Div. | of steamed sweet potato | Taste | Flavor | Texture | peeling |
| Test Group 4 | Sweet potato processed food from | 3.9 | 3.8 | 2.7 | 3.4 |
| | pasteurization of a raw sweet potato | | | | |
| | not placed in a package | | | | |
| Example 1 | Sweet potato processed food from | 4.2 | 4.3 | 3.9 | 4.4 |
| | pasteurization of a raw sweet potato | | | | |
| | placed in a laminated foil packaging | | | | |
| | sheet | | | | |
| Example 2-1 | Sweet potato processed food from | 4.5 | 6.0 | 4.9 | 5.1 |
| | pasteurization of a raw sweet potato | | | | |
| | wrapped with a mulberry leaf and | | | | |
| | then placed in a laminated foil | | | | |
| | packaging sheet | | | | |
| Example 2-2 | Sweet potato processed food from | 4.4 | 6.1 | 4.8 | 5.0 |
| | pasteurization of a raw sweet potato | | | | |
| | wrapped with a lotus leaf and then | | | | |
| | placed in a laminated foil packaging | | | | |
| | sheet | | | | |

Referring to Table 3, as for baked sweet potatoes, the sweet potato processed foods prepared by the processing method of the present invention (Examples 3, 4-1 and 4-2), in spite of being stored for one month after preparation, were similar in taste and ease of peeling to the Test Group 3 and even superior in taste to the Test Group 2, where the Test Groups 2 and 3 were consumed immediately after the processing procedure. The reason of this presumably boils down to the use of red clay in baking sweet potatoes to enhance the taste of the sweet potatoes in Test Group 3 and Examples 3, 4-1 and 4-2. The sweet potato processed foods of the present invention were far superior in flavor and texture (mouthfeel) to the Test Groups 2 and 3.

Referring to Table 4, as for steamed sweet potatoes, the sweet potato processed foods prepared by the processing method of the present invention (Examples 1, 2-1 and 2-2), in spite of being stored for one month after preparation, were superior in taste, flavor, texture (mouthfeel), and ease of peeling to the Test Group 4.

In particular, the sweet potato processed foods using sweet potatoes wrapped in a plant leaf (e.g., a mulberry or lotus leaf) according to the present invention as in Examples 2-1, 2-2, 4-1, and 4-2 of Tables 3 and 4 were significantly superior in flavor to those using sweet potatoes not wrapped in a plant leaf. The reason of this presumably lies in that the process of pasteurizing the sweet potatoes wrapped in a plant leaf allowed the flavor of the plant leaf to penetrate into the sweet potatoes only to reduce the burnt smell of the baked sweet potatoes and increase the sweet flavor of the sweet potatoes. As implied from the penetration of the flavor of the plant leaf into the sweet potatoes, the active ingredients of the plant leaf were also presumably able to penetrate into the sweet potatoes during the pasteurization process.

If not shown in the present invention, the sweet potato processed foods prepared by the processing method of the present invention and stored for one year after preparation were similar in palatability associated with taste, flavor, texture (mouthfeel), and ease of peeling to those prepared by the processing method of the present invention and stored for one month.

Further, the baked sweet potatoes prepared by baking at 160° C. for 80 minutes in a kiln according to the present invention were sweeter and easier to peel than those prepared by a general baking method, namely, baking at 190° C. for 55 minutes.

In conclusion, the sweet potato processed foods prepared by the processing method of the present invention were capable of being preserved at room temperature for a long time, while maintaining the taste, flavor, texture (mouthfeel), or the like acquired right after preparation procedures.

As described above, the present invention ensures that a sweet potato processed food can be preserved at room temperature for a long period of time while maintaining the taste, flavor, texture (mouthfeel), or the like acquired right after preparation procedures, given that the processed food is prepared by a process including: (1) washing and drying a sweet potato; (2) packaging each sweet potato of the step (1) in a laminated foil packaging sheet; and (3) pasteurizing the packaged sweet potato of the step (2) at 121 to 150° C. for 25 to 35 minutes. Therefore, the present invention is expected to bring out an increase in the income of sweet potato farmers and thus acquire high industrial availability by using the method for processing sweet potatoes into baked or steamed sweet potatoes that are readily consumable without trouble to conduct a separate cooking procedure, distributable at room temperature, and preservable for a long period of time.

1. A processing method for sweet potato enabling long-term preservation of a sweet potato at room temperature with enhanced quality using penetration of flavor and active ingredients of plant leaves into a sweet potato, the processing method comprising:
(1) washing and drying a sweet potato;
(2) wrapping the sweet potato of the step (1) with plant leaves and packaging each sweet potato in a laminated foil packaging sheet; and
(3) pasteurizing the packaged sweet potato of the step (2) at 121 to 150° C. for 25 to 35 minutes.

2. The processing method for sweet potato as claimed in claim 1, wherein the washing of the step (1) is spraying ultrasonic wash water at high pressure.

3. The processing method for sweet potato as claimed in claim 1, wherein the drying of the step (1) is infrared drying.

4. The processing method for sweet potato as claimed in claim 1, wherein the plant leaves are selected from the group consisting of mulberry leaves, lotus leaves, mandarin melon berry leaves, Siberian ginseng leaves, kalopanax leaves, kudzu leaves, basil leaves, yerba mate leaves, Camellia sinensis (green tea) leaves, and pine tree leaves.

5. The processing method for sweet potato as claimed in claim 1, wherein the processing method for sweet potato further comprises baking the sweet potato of the step (1) to prepare a baked sweet potato.

6. The processing method for sweet potato as claimed in claim 5, wherein the baked sweet potato is prepared by placing the sweet potato in a kiln filled with a layer of red clay or covering the sweet potato with red clay in a kiln, and then baking the sweet potato at 150 to 160° C. for 80 to 100 minutes.

7. The processing method for sweet potato as claimed in claim 1, wherein the long-term preservation lasts 12 to 18 months.

8. A sweet potato processed food prepared by the processing method as claimed in claim 1.
